(19) United States
(12) Patent Application Publication
(10) Pub. No.: US 2021/0117213 A1
(43) Pub. Date: Apr. 22, 2021

(54) AUTOMATED SERVICE AGENT FOR SERVICING ISSUES DESCRIBED IN A GROUP COMMUNICATION CHANNEL

(71) Applicant: MOVEWORKS, INC., Mountain View, CA (US)

(72) Inventors: Jing Chen, Redwood City, CA (US); Ye Wang, Santa Clara, CA (US); Ankoor Shah, Saratoga, CA (US); Sushanth Bhaskarabhatla, San Francisco, CA (US); Jiang Chen, Fremont, CA (US); Vaibhav Nivargi, Palo Alto, CA (US); Varun Singh, Mountain View, CA (US); Bhavin Nicholas Shah, Fremont, CA (US)

(21) Appl. No.: 16/660,679

(22) Filed: Oct. 22, 2019

(51) Int. Cl. G06F 9/451; H04M 3/51; H04L 29/06; G06F 11/07

(52) U.S. Cl. CPC G06F 9/453; H04M 3/5191; G06Q 30/0635; G06F 11/0793; H04L 65/4046

(57) ABSTRACT

An automated service agent may be used to service issues discussed by users of a group communication channel. In the process of servicing the issue, the automated service agent may differentiate the roles of the users and identify a requester of the issue. In one scenario, the automated service agent may contact the requester in a private communication channel to collect more detailed or private information from the requester. The issue may be resolved in the private communication channel with the requester. Information may be posted back to the group communication channel to inform the other users as to the successful resolution of the issue and how the issue was resolved. While communicating with the requester in the private communication channel, messages may be posted to the group communication channel to keep the other users up to date on the progress of resolving the issue in the private communication channel.

### FIELD OF THE INVENTION

The present invention relates to the use of an automated service agent to service one or more issues described or discussed in a group communication channel.

### BACKGROUND

The use of group communication channels (e.g., communication means that allow communication between a group of individuals) has become more widespread, allowing users of the group communication channels to ask questions in real time to human agents, and to share knowledge among users. However, due to the increased use of group communication channels by users, it has become more time consuming for the human agents to respond to requests and/or questions from the users, and more difficult for an organization to monitor the service level agreement (SLA) or the quality of answers provided. Furthermore, it has become more challenging for users to search for answers in the chat history of a group communication channel, as users may need to browse through a lengthy chat history in order to locate relevant postings that contain answers to issues. Users may also ask questions that have been previously asked (i.e., ask duplicate questions), which may cause human agents to post repeated answers.

The above-described problems and other problems present in the servicing of issues described in a group communication channel are addressed by the techniques discussed hereinbelow.

### SUMMARY OF THE INVENTION

In accordance with one embodiment of the invention, machine learning may be applied to a group communication channel in order to provide more relevant and timely answers to users, and further to reduce the workload of human agents. More specifically, machine learning may be used to train an automated service agent, which can be used to identify issues described in messages, triage the issues (e.g., resolve basic issues in real time, reach out to a human agent as needed for more advanced or complex issues), and collect user information before handing an issue off to a human agent. The automated service agent can also increase the readability of the chat history of a group communication channel, by, for example, labeling one or more time points at which a communication thread of the group communication channel has been assigned (either to an automated service agent or to a human agent), and/or labeling one or more time points at which an issue of the communication thread has been resolved. If not already apparent, a communication thread refers to a time ordered sequence of messages from users and agents that generally relate to a single topic.

In the process of resolving an issue, the automated service agent may differentiate the roles of the participants, and identify the requester of the issue. Once the requester has been identified, the automated service agent may contact the requester on a private communication channel (e.g., via a direct message (DM) chat mode) in order to collect more detailed or private information from the requester. When a checkpoint or milestone has been reached (e.g., requester is denied a service, approval request has been sent to a supervisor, the issue has been fully resolved), a message may be posted back to the group communication channel so as to keep the other participants (and possibly human agents) of the group communication channel informed on the resolution status of the issue.

In accordance with one embodiment of the invention, a top level view of the group communication channel may display a sparse representation of multiple concurrent communication threads (also known as “topics”). The top level view may include a brief synopsis of the issue of each of the threads, graphical status indicators (e.g., an “eyes” emoji indicating that a thread has been assigned, a “checkmark” emoji indicating that an issue described or discussed in a thread has been resolved), and graphical user interface elements that when selected cause the top level view of a thread to be expanded into a bottom level view. The bottom level view may include the complete sequence of messages that are communicated between the one or more users of the group communication channel and the automated service agent.

In accordance with one embodiment of the invention, the benefits of the “networking effect” can be leveraged in the group communication channel. For example, useful answers can be shared among all participants. As another example, common incidents (e.g., outages) or trending topics (e.g., new acquisitions, company events) that affect a large number of users can be detected by monitoring the group communication channel, allowing the automated service agent to make proactive announcements to the group communication channel and/or to alert human agents to prepare for anticipated issues or risks.

In accordance with one embodiment of the invention, the service level agreement (SLA) in a group communication channel can be maintained and/or managed by the use of the automated service agent. For example, an automated service agent can monitor when an issue described in a thread has not been resolved after a long period of time, and contact a human agent (or other user) to follow up with the unresolved issue. Use of an automated service agent is advantageous as an automated service agent can work around the clock, with virtually no downtime.

These and other embodiments of the invention are more fully described in association with the drawings below.

### BRIEF DESCRIPTION OF THE DRAWINGS

FIG. 1 depicts a system diagram including one or more client devices communicatively coupled to one or more servers via a communication network, in accordance with one embodiment of the invention.

FIG. 2A depicts a time sequence diagram of the communication between one or more users and an automated service agent via a group communication channel, in which the automated service agent is able to service the issue on the spot, in accordance with one embodiment of the invention.

FIG. 2B depicts a time sequence diagram of the communication between one or more users and an automated service agent via a group communication channel and the communication between one of the users and the automated service agent via a private communication channel, in accordance with one embodiment of the invention.

FIG. 2C depicts a time sequence diagram of the communication that occurs via a group communication channel and a private communication channel, and more specifically includes posting, in the group communication channel, a status of the communication that occurs in the private communication channel, in accordance with one embodiment of the invention.

FIG. 2D depicts a time sequence diagram of the communication that occurs via a group communication channel and a private communication channel, and more specifically includes the collection of user information via the private communication channel, in accordance with one embodiment of the invention.

FIG. 2E depicts a time sequence diagram of the communication that occurs via a group communication channel and two private communication channels, and more specifically includes communication between one of the users and the automated service agent in one of the private communication channels and communication between a human agent and the automated service agent in another one of the private communication channels, in accordance with one embodiment of the invention.

FIGS. 3A-3B depict a flow diagram of a process to service issues that are described or discussed in a group communication channel, in accordance with one embodiment of the invention.

FIG. 4 depicts a flow diagram of a process that may be performed by a group communication application, in accordance with one embodiment of the invention.

FIG. 5A depicts an example of a top level view of multiple communication threads of a group communication channel, in accordance with one embodiment of the invention.

FIG. 5B depicts an example of a bottom level view of one of the threads of the group communication channel, in accordance with one embodiment of the invention.

FIG. 6 depicts an example of communication between one of the users and an automated service agent that takes place via a private communication channel, in accordance with one embodiment of the invention.

FIG. 7 depicts a flow diagram of a process for facilitating task automation, in accordance with one embodiment of the invention.

FIG. 8 depicts a flow diagram of a process for facilitating an automated communication between a user and an automated service agent, in accordance with one embodiment of the invention.

FIG. 9 depicts a flow diagram of a process for facilitating an automated communication between a user and an automated service agent, in accordance with one embodiment of the invention.

FIG. 10 depicts components of a computer system in which computer readable instructions instantiating the methods of the present invention may be stored and executed.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. Descriptions associated with any one of the figures may be applied to different figures containing like or similar components/steps.

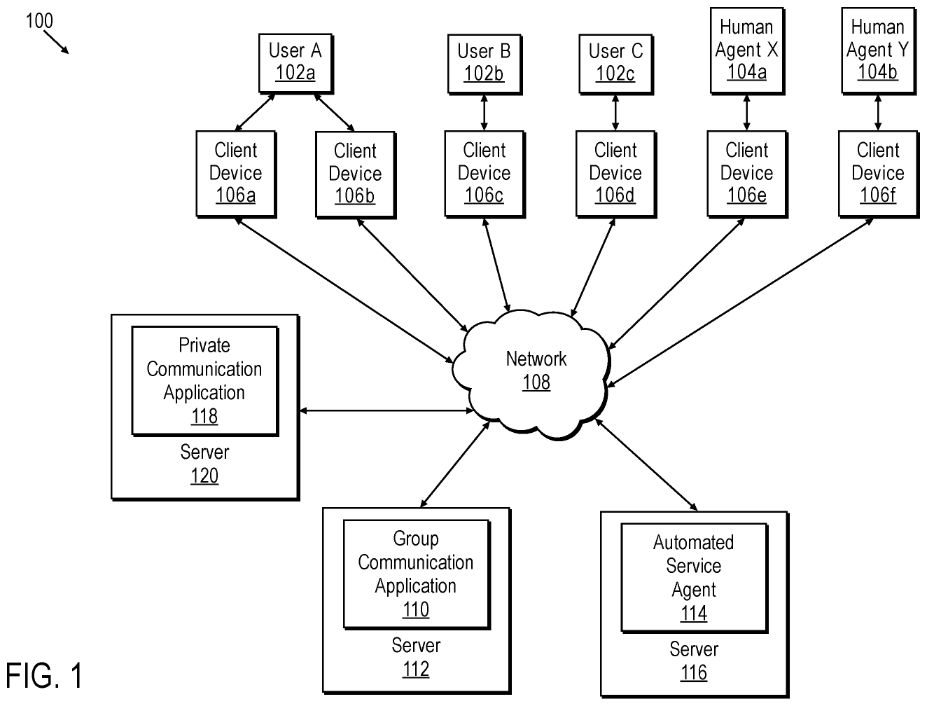

FIG. 1 depicts system diagram 100 including one or more client devices (106a, . . . , 106f) communicatively coupled to one or more servers (112, 116, 120) via communication network 108. A group of users may use a group communication channel that is facilitated by the devices (e.g., client devices) and components (e.g., network 108, server 112, group communication application 110) of system diagram 100 to communicate with one another. In the embodiment depicted in FIG. 1, the group of users includes user A 102a, user B 102b and user C 102c. It is understood that in other embodiments, a group of users may generally include two or more users.

In the embodiment of interest, the communication between the group of users describes or relates to an issue (e.g., a problem such as a login error, a request for a resource such as hardware or software, a knowledge question, etc.). Automated service agent 114, which may be instantiated on server 116, may monitor one or more messages that are communicated via the group communication channel in order to identify the issue. In some instances, the automated service agent may be able to determine a resolution to the issue on the spot without human intervention immediately upon identifying the issue (e.g., by querying the issue in a database and retrieving a resolution to the issue from the database and/or through diagnosis and resolution using artificial intelligence means), and communicate the resolution to the group of users via the group communication channel (e.g., post message including the public Wi-Fi password, post message with a meeting location, etc.).

In other instances, it may not be possible to address the issue on the spot, and automated service agent 114 may need to communicate privately with one of the users (via one or more communication channels other than the group communication channel) in order to address the issue. The private communication may take place via a private communication channel that is only accessible to one of the users and automated service agent 114. A private communication channel generally refers to the communication means (e.g., client devices 106a, . . . 106f, network 108, server 120, private communication application 118) that allows two entities (occasionally, more than two entities) to communicate privately with one another. In most embodiments described herein, the two entities are a human and automated service agent 114. However, it is possible that the two entities could be two humans (e.g., two people communicating privately with one another). In some instances where automated service agent 114 needs to communicate privately with multiple users, each of the users may communicate with the automated service agent 114 via his or her own private communication channel. In other instances, more than two entities may use a single private communication channel to communicate privately with one another (e.g., one automated service agent and a group of approvers). In such cases, a private communication channel may be more specifically referred to as a private group communication channel.

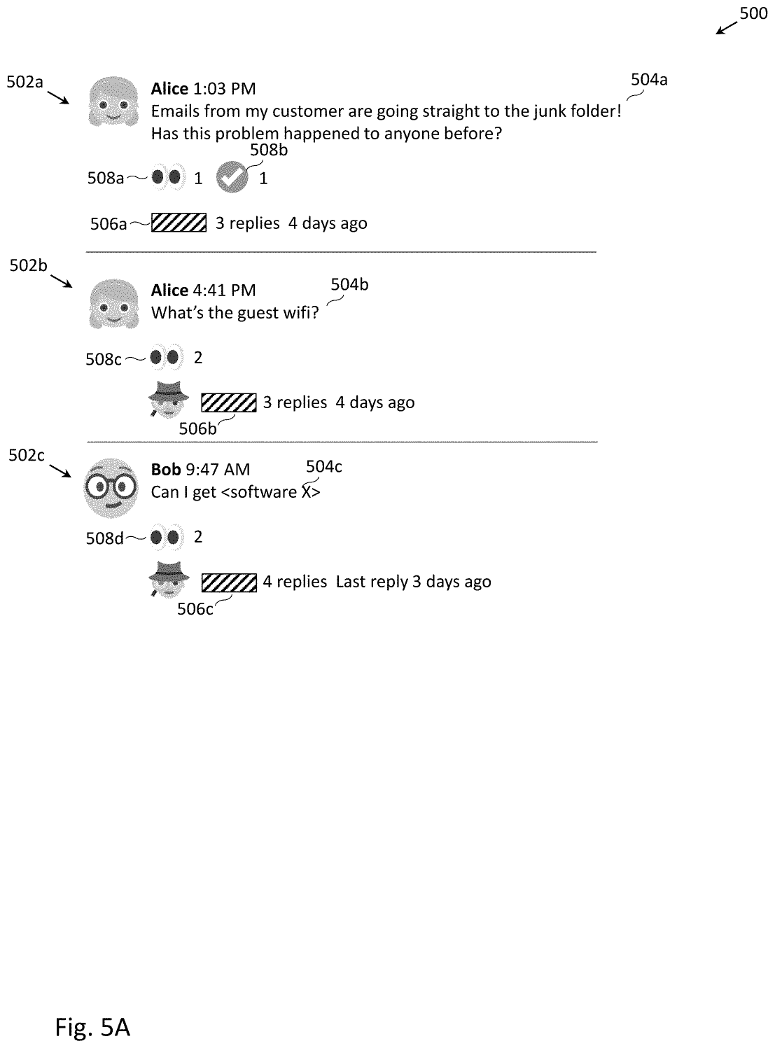

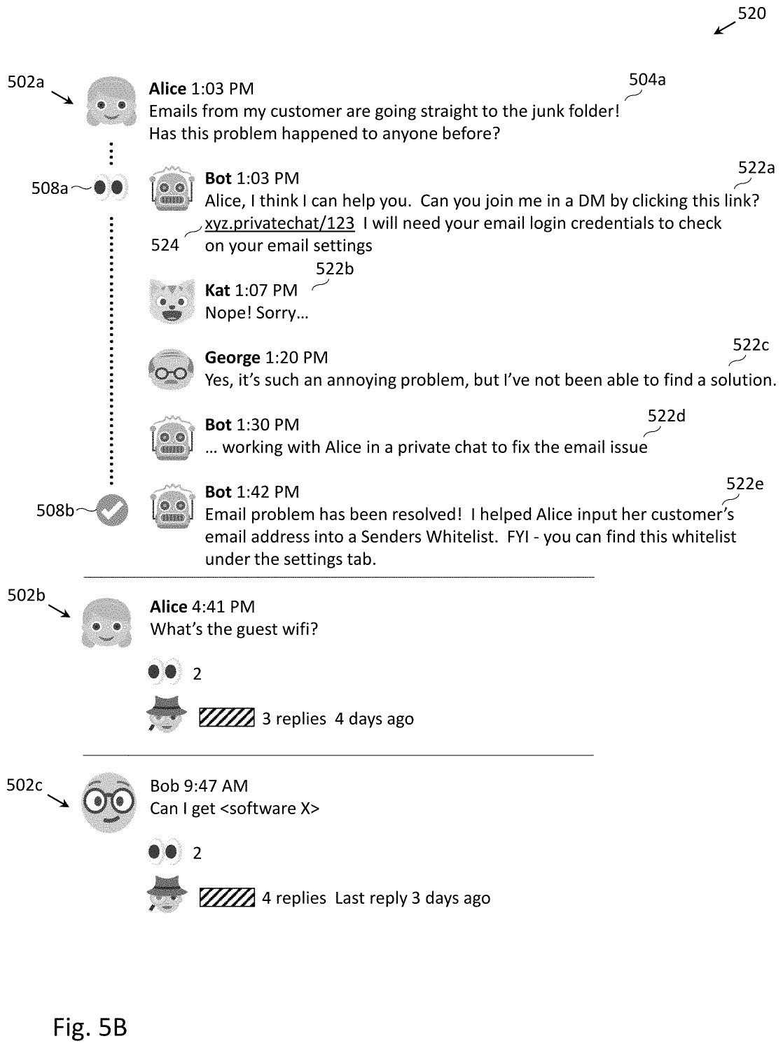

To further elaborate on the distinctions between a group communication channel and a private communication channel, a group communication channel may be a channel in which all participants of the group communication channel have access to most or all of the questions and/or discussions (also called communication threads) that are communicated in the channel. One group communication channel may typically include multiple unrelated discussions (as in the example of FIG. 5A). For each discussion, only a (small) subset of the participants of the group communication channel may actively post messages, although all participants of the group communication channel may be allowed to view and/or access the discussion if they have sufficient interest. Typically, participants of the group communication channel may have different roles (e.g., employees seeking help, and agents providing help). In contrast, a private communication channel may be a channel that is only visible to the participants of the private communication channel, and at least one participant of the group communication channel might be excluded from accessing the content of the private communication channel. Typically, a private communication channel is a one-to-one channel between two entities, for example, a service seeker and an agent, or an agent and an approver for the request, in which the agent can be a human agent or an automated service agent.

Communication via a private communication channel may be preferred rather than communication via the group communication channel in the instance that sensitive or private information (e.g., a date of birth, a social security number, an address, a bank account number, a credit card number, a user id, a password, medical data, etc.) needs to be communicated between the user and automated service agent 114 or simply because of a desire or policy not to crowd the group communication channel with multiple posts that represent only intermediate communications/steps during an issue resolution procedure. In the context of trouble-shooting an issue, a user may use the private communication channel to privately communicate to automated service agent 114 more detailed information that might not be of interest to or suitable for viewing by the other users of group communication channel 202 (e.g., measures the user has already attempted without any success).

During communication with one of the users via the private communication channel, a status of the issue resolution process may occasionally be posted to the group communication channel by automated service agent 114 so as to keep users of the group communication channel and/or human agents monitoring the channel informed of the progress (or lack of progress) with resolving the issue. Status updates may be posted upon the occurrence of milestones or checkpoints, such as the expiration of predetermined time periods since the initial posting of the issue and/or attention to that issue by the automated service agent, a user being denied a service, an approval request being sent, a user rejecting the help of automated service agent 114, a ticket being filed to request help from an agent (either a human agent or an automated service agent), an issued being fully resolved, etc.

In some instances, while communicating with the user via a private communication channel, automated service agent 114 may determine that assistance from one or more human agents 104a, 104b is needed to resolve the issue. To contact the human agent, automated service agent 114 may post a message on the group communication channel, in the instance that one or more human agents 104a, 104b are monitoring the group communication channel. In addition or alternatively, automated service agent 114 may directly contact one or more human agents via a private communication channel or other communication means (e.g., an alert/message to a mobile phone, email, etc.). The term “human agent” may broadly encompass any person that may be of assistance to resolve the issue, and may include a member of an enterprise's information technology department, a supervisor of one of the users of the group, a system administrator, a colleague of one of the users of the group, one of the users of the group, etc.

Once the communication via the private communication channel has concluded (or temporarily ceased), a summary of the communication that occurred in the private communication channel may be posted on the group communication channel. The summary of the communication may include an outcome of the automated service agent's attempt to resolve the issue (whether successful, or not successful). The summary of the communication may include answers to a knowledge question, the reasons for a login failure, the procedure to request a software update, the procedure to order a piece of hardware equipment, etc. Such a “post back” to the group communication channel may take advantage of the “networking effect” on a group communication channel such that useful information received by one of the users may be benefit and enlighten all users of the group communication channel.

If not already apparent, a group communication channel may be hosted by the Lync®, Skype for Business, or Teams, messaging applications from Microsoft Corp.® of Redmond, Wash.; the WhatsApp® messaging application from Facebook Inc.® of Menlo Park, Calif.; or the Slack® messaging application from Slack Technologies® of San Francisco, Calif., or other messaging application/platform. In particular, there are two forms of communication in the Slack messaging application that could be used as a group communication channel. First, the “public channel” in the Slack messaging application could be used as a group communication channel, in which messages are accessible to all members of a team of individuals. Second, the “direct message” in the Slack messaging application could be used as a group communication channel, in which multiple participants are invited to a direct message thread. A group communication channel may also include an Internet forum (or message board), in which a group of people (who may or may not be members of the same enterprise or business) may communicate with one another in the form of posted messages. A group communication channel may also include a chat room. A chat room may be similar to an Internet forum, except that users typically communicate with one another using shorter expressions, rather than longer expressions, such as full sentences. A group communication channel may also be hosted by an short message service (SMS) application (such as that provided by the iOS® operating system from Apple Inc.® of Cupertino, Calif.; or provided by the Android® operating system from Alphabet Inc.® of Mountain View), in which a group of users send text messages that are visible to a group of users. A group communication channel may also include a video conference (such as that provided by Zoom Video Communications® of San Jose, Calif.; or provided by BlueJeans Network® of San Jose, Calif.), in which users can communicate with one another via video communication, voice communication, chat via a chat window, and/or any combination thereof.

If not already apparent, a private communication channel may also be hosted by any of the above-mentioned messaging or other applications. In particular, there are two forms of communication in the Slack messaging application that could be used as a private communication channel. First, the “private channel” of the Slack messaging application could be used as a private communication channel of the invention. In the Slack messaging application, members must be invited to a private channel in order to view, search and participate in that channel's discussion. Second, the “direct message” (DM) of the Slack messaging application could be used as a private communication channel of the invention, in which a single user and an automated service agent are the only participants of a direct message thread. In some cases, the software application (or operating system) used to host a private communication channel may be the same as that used to host a group communication channel. The only difference may be how the software application is used. In a private communication channel, a “chat” (or conversation) is created in a messaging application that is only between one user and an automated service agent, whereas in a group communication channel, a “group chat” is created in the messaging application with multiple users (and possibly the automated service agent) as participants.

In a group communication channel, automated service agent 114 may be explicitly listed or added as a participant or may be implicitly implemented as a default participant (i.e., a background process). For instance, in a group communication channel using a group SMS session, an automated service agent may be assigned a phone number (e.g., 123-456-7890), and if the users decide that they would like the automated service agent to participate in the group SMS session, the phone number of the automated service agent can be included as one of the participants of the group chat. Alternatively, in an Internet forum, it may initially be unclear that an automated service agent is monitoring the communication (i.e., automated service agent is not explicitly listed as a participant), and the participants may be surprised (but pleased) when an automated service agent posts a message on the Internet forum with a resolution to an issue described in the Internet forum.

A group communication channel may be provided by group communication application 110. In the case of a web-based or a cloud-based group communication channel, group communication application 110 may be instantiated on server 112 (as depicted in FIG. 1), and such group communication application 110 may be accessible to each of the users via a web browser of the client device. Alternatively, group communication application 110 may be instantiated on one or more of the client devices (106a, . . . , 106f) (e.g., group communication application may be part of the operating system of the client device), and/or may be instantiated on both server 112 and one or more of the client devices (106a, . . . , 106f).

Similarly, one or more private communication channels may be provided by private communication application 118. In the case of a web-based or a cloud-based private communication channel, private communication application 118 may be instantiated on server 120 (as depicted in FIG. 1), and such private communication application 118 (possibly a separate instance thereof) may be accessible to each of the users via a web browser of the client device. Alternatively, private communication application 118 may be instantiated on one or more of the client devices (106a, . . . , 106f) (e.g., private communication application may be part of the operating system of the client device), and/or may be instantiated on both server 120 and one or more of the client devices (106a, . . . , 106f).

Users may communicate with each other, with automated service agent 114 and/or with one or more human agents via one or more client devices. As shown in FIG. 1, user A 102a may have possession of two client devices (106a and 106b). For example, user A 102a may use client device 106a (e.g., a laptop) to communicate in a group communication channel, and may use client device 106b (e.g., a smartphone) to communicate in a private communication channel. As another example, user B 102b may use client device 106c to communicate in both a group communication channel and a private communication channel.

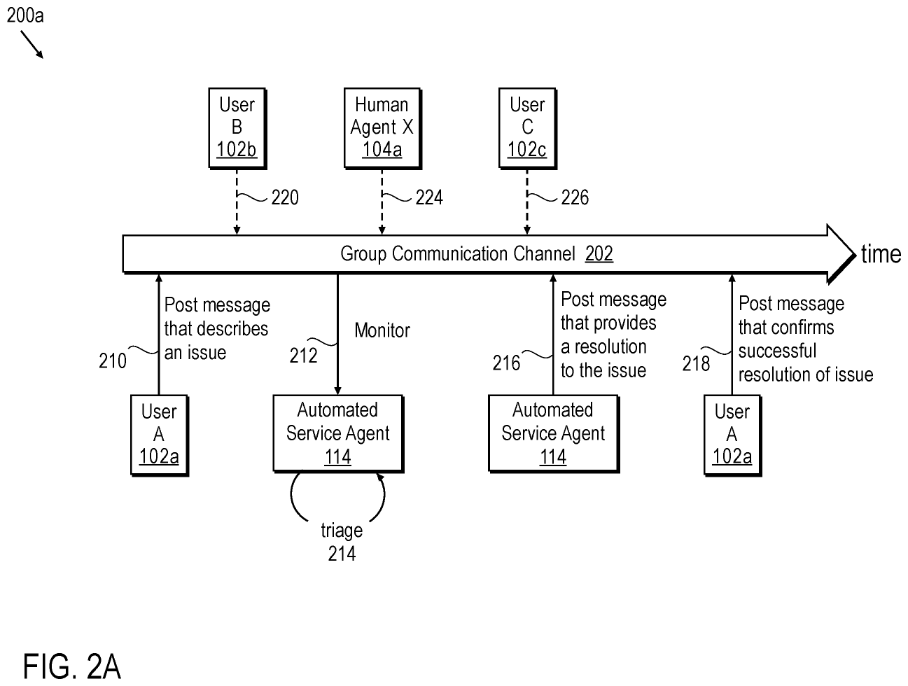

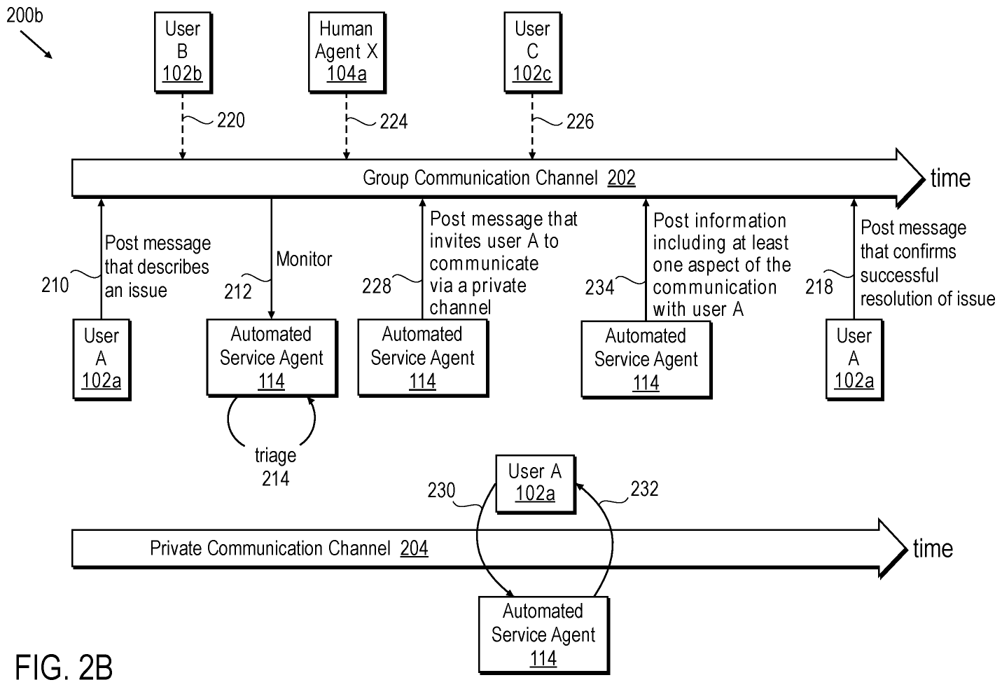

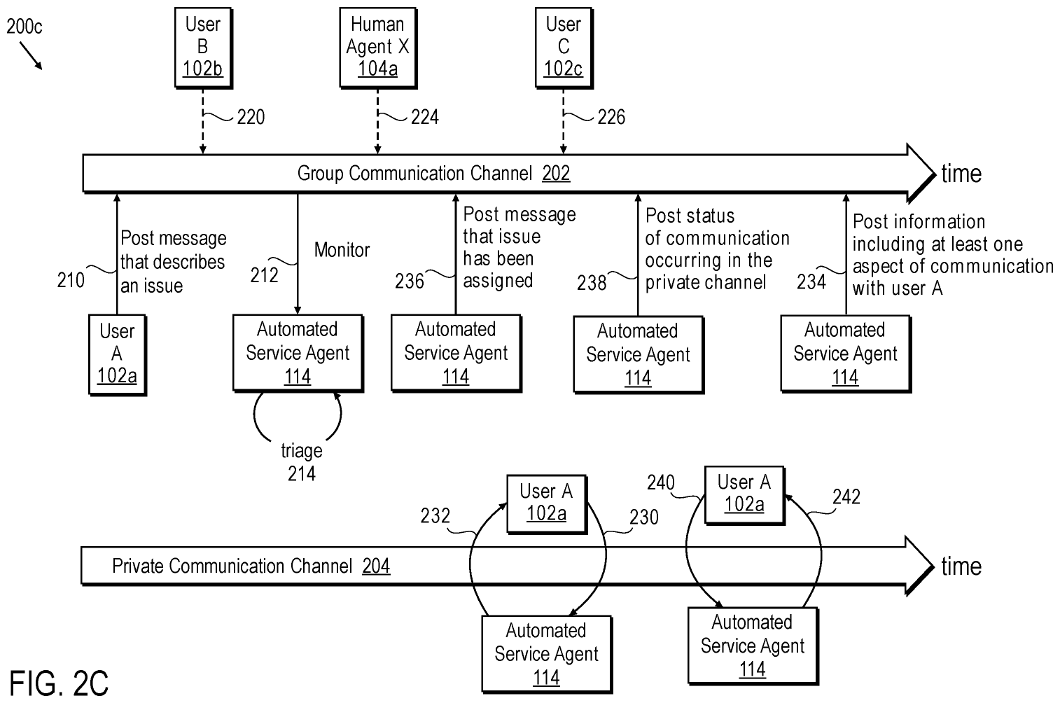

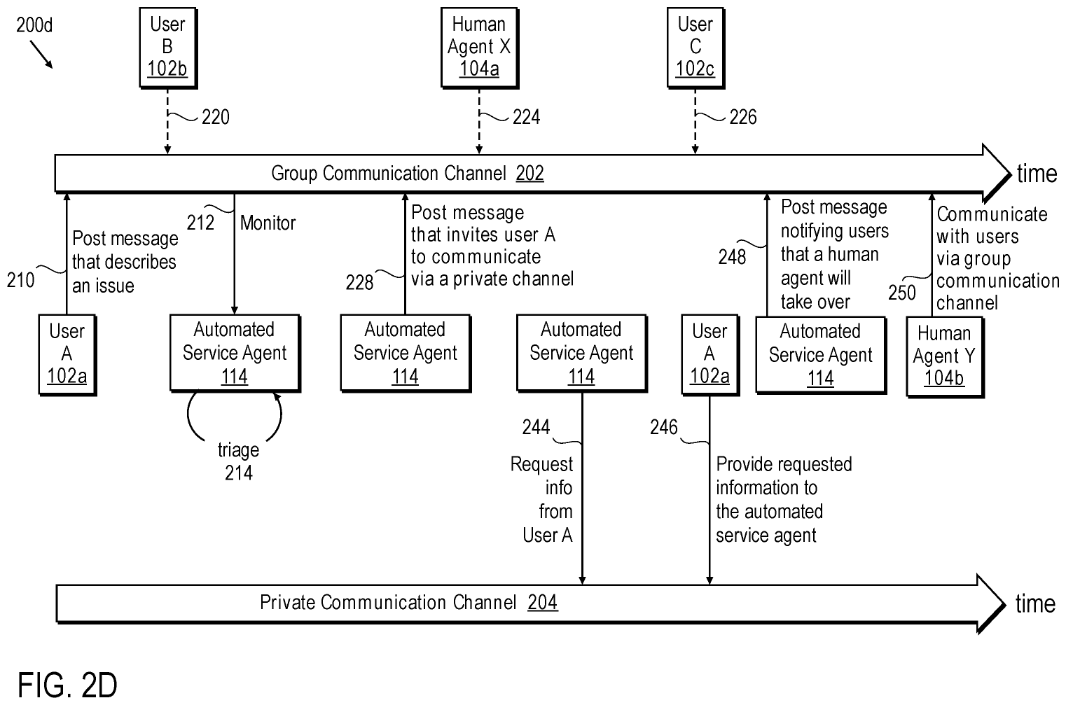

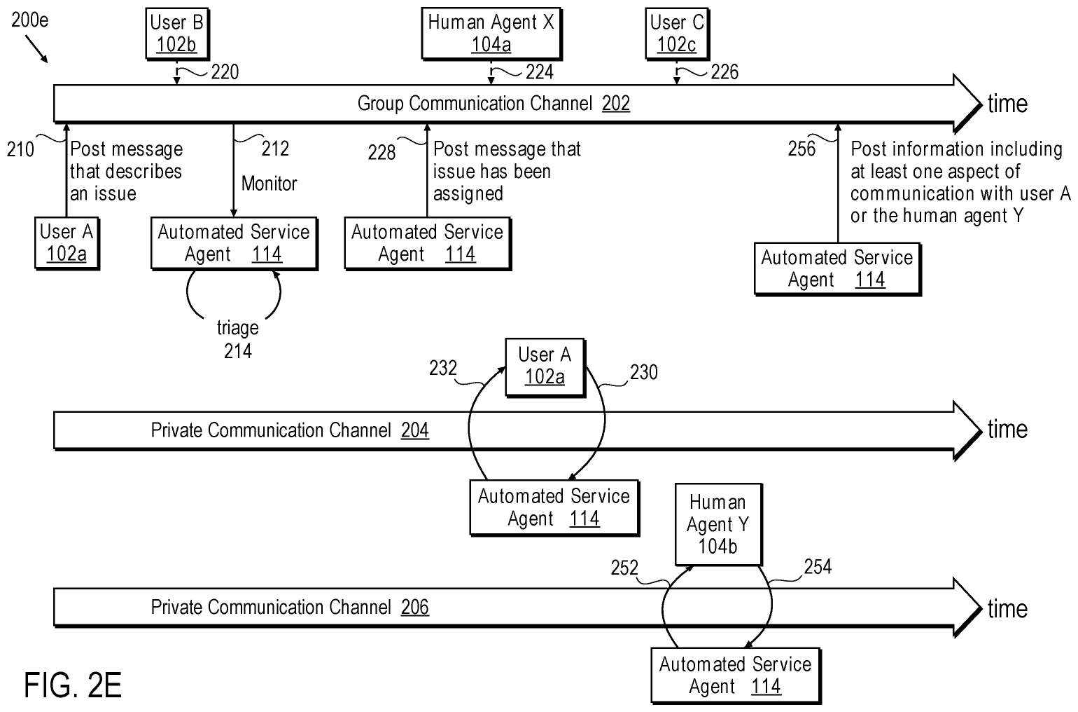

FIGS. 2A-2E describe various scenarios in which an automated service agent may be used to service an issue (or may attempt to service an issue) discussed or described in a group communication channel. In the description that follows, the automated service agent will be described to perform many actions, such as recognizing an issue from messages, determining whether use of the private communication channel would be helpful, determining a resolution to an issue, etc. It should be appreciated that such determinations by the automated service agent may require the automated service agent to first be trained with training data. The training data may include desired or known pairings of input to and output from a model (e.g., a neural net). For example, to train the automated service agent to recognize an issue from messages, training data may include messages that are paired with an issue that a human has determined is described in the messages. As another example, to train the automated service agent to determine a resolution to an issue, the automated service agent may be trained with known pairings of issues and resolutions, such known pairings being collected from publicly available data (e.g., from FAQs posted on a website), and private enterprise domain data (e.g., service tickets and service ticket resolutions stored in a database of an enterprise). Private enterprise domain data may also include IT service management (ITSM) data, human resource (HR) data, facility data, etc. Based on such training data, parameters of the model may be optimized. After the parameters of the model have been optimized, the model may be used by the automated service agent to perform the determinations described below.

FIG. 2A depicts time sequence diagram 200a of the communication between one or more users (102a, 102b, 102c) and automated service agent 114 via group communication channel 202, in which automated service agent 114 is able to service or address the issue on the spot. While not explicitly depicted in FIG. 2A, it is assumed that all the communication depicted in FIG. 2A is part of a single communication thread (or topic), in which a communication thread generally refers to a time-ordered group of messages that relate to a common topic or issue. Communication threads will be discussed in more detail in FIG. 5A. If there are multiple communication threads, it is understood that time sequence diagram 200a depicted in FIG. 2A could be carried out in each of the communication threads.

In step 210, user A 102a may post a message on group communication channel 202 that describes an issue. Example messages are provided in FIG. 5A, and include “Emails from my customer are going straight to the junk folder! Has this problem happened to anyone before?”, “What's the guest wifi?” and “Can I get <software X>”.

In step 212, automated service agent 114 may monitor group communication channel 202. For simplicity of illustration, the monitoring is depicted as a single step in FIG. 2A, but it is understood that the monitoring of messages communicated via group communication channel 202 may be a continuous process, such that automated service agent 114 may monitor all messages that are communicated via group communication channel 202.

In step 214, a triage operation may be performed by automated service agent 114. The triage operation may include one or more of determining whether the communication thread has already been assigned (either to an automated service agent or to a human agent), identifying an issue described in one or more messages of the communication thread, determining whether a resolution to the issue can be identified on the spot, determining whether the issue should be assigned to a human agent (in the case of a more complex issue), etc. In the example of FIG. 2A, during the triage operation, automated service agent 114 is able to determine a resolution to the issue on the spot.

In step 216, automated service agent 114 may post a message on group communication channel 202 that provides a resolution to the issue. For instance, the message may include the guest Wi-Fi login and password. In step 218, user A 102a may post a message on group communication channel 202 that confirms the successful resolution of the issue.

Unspecified interactions 220, 224 and 226 from user B 102b, human agent X 104a, and user C 102c, respectively, are also depicted. Examples of these interactions could be these participants reading messages on group communication channel 202; these participants posting messages on group communication channel 202; etc. These unspecified interactions are included in FIG. 2A to emphasize that group communication channel 202 is utilized by a group of users.

FIG. 2B depicts time sequence diagram 200b of the communication between one or more users (102a, 102b, 102c) and automated service agent 114 via group communication channel 202 and the communication between one of the users 102a and automated service agent 114 via private communication channel 204. While not explicitly depicted in FIG. 2B, it is again assumed that all the communication depicted in group communication channel 202 of FIG. 2B is part of a single communication thread (or topic).

In step 210, user A 102a may post a message on group communication channel 202 that describes an issue. In step 212, automated service agent 114 may monitor group communication channel 202. In step 214, a triage operation similar to that described above in FIG. 2A may be performed by automated service agent 114. In the example of FIG. 2B, during the triage operation, automated service agent 114 is able to identify an issue from the messages posted in group communication channel 202, but automated service agent 114 is unable to determine a resolution to the issue on the spot. During the triage operation, automated service agent 114 additionally determines that user A 102a is the requestor of the issue (e.g., based on the identity of the user who first describes the issue). During the triage operation, automated service agent 114 additionally determines that use of private communication channel 204 would be helpful to resolve the issue.

In step 228, automated service agent 114 may post a message on group communication channel 202 that invites user A 102a to communicate with automated service agent 114 via private communication channel 204. One example of such invitation is illustrated in FIG. 5B, in which the user is invited to click on (or more generally select) a link to join a direct message (DM). Other examples may include asking the user to send an SMS message to a certain phone number, in which automated service agent 114 will be able to receive and send SMS messages via the same phone number. In the scenario of FIG. 2B, it is assumed that the user accepts the invitation from the automated service agent to join the private communication channel.

In steps 230 and 232, user A 102a and automated service agent 114 communicate via private communication channel 204 in order to attempt to resolve the issue. To emphasize, the same “bot” instance (i.e., automated service agent 114) may communicate with user A 102a via group communication channel 202 and private communication channel 204. An advantage of using the same bot instance in group communication channel 202 and private communication channel 204 is that there is no loss in context by automated service agent 114. Automated service agent 114 can apply whatever knowledge it learns in group communication channel 202 to the communication in private communication channel 204, and vice versa.

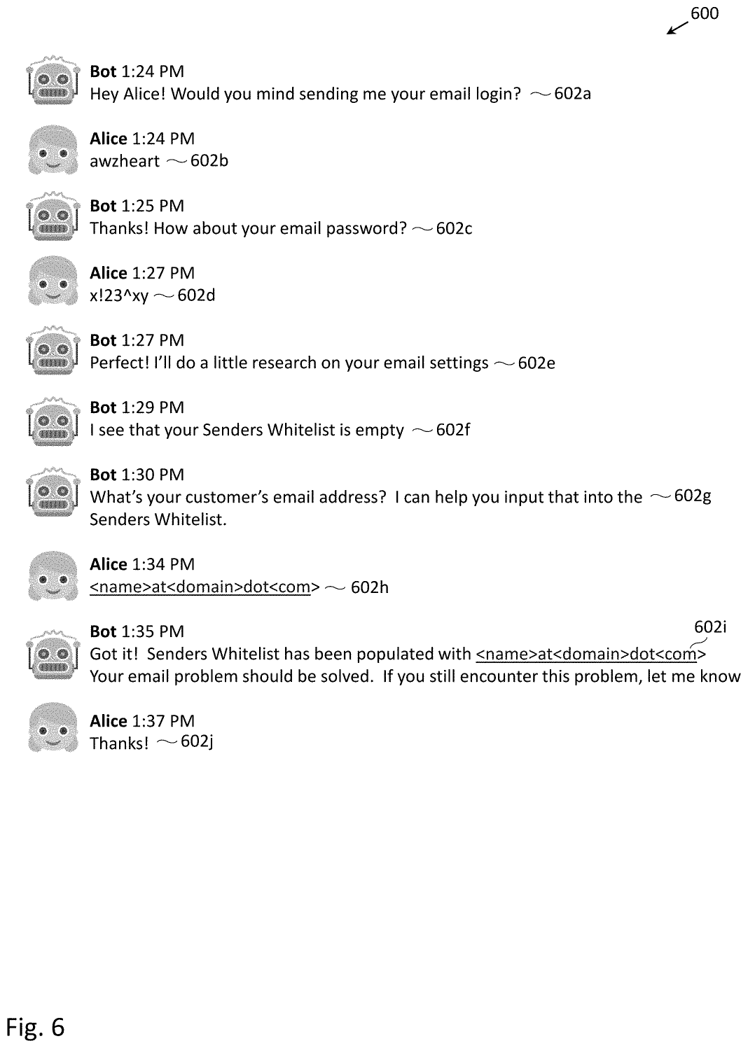

The communication that takes place in private communication channel 204 may include automated service agent 114 sending a request to user A 102a (step 232) and user A 102a responding to the request (step 230) and/or user A 102a sending a question to automated service agent 114 (step 230) and automated service agent 114 replying with an answer (step 232). Steps 230 and 232 may be repeated as necessary. One example of the communication via private communication channel 204 will be provided below in FIG. 6.

Once the communication via the private communication channel has concluded (or temporarily ceased), automated service agent 114 may post, in group communication channel 202, information including at least one aspect of the communication with user A 102a that occurred in private communication channel 204. Such information could include a summary of the discussion between user A 102a and automated service agent 114, could include steps to place a purchase order, could include user A 102a rejecting the assistance of automated service agent 114, could include steps to request a software upgrade, could include the outcome of the attempt to resolve the issue (whether successful or not successful, etc.), etc. In the scenario of FIG. 2B, it is assumed that the issue is successfully resolved, so user A 102a posts a message that confirms the successful resolution of the issue (step 218). While not depicted in FIG. 2B for conciseness, step 218 may be preceded by automated service agent 114 posting a message on group communication channel 202, inquiring whether the issue has been resolved in a satisfactory manner.

FIG. 2C depicts time sequence diagram 200c of the communication that may occur via group communication channel 202 and private communication channel 204, and more specifically includes posting, in group communication channel 202, a status of the communication that occurs in private communication channel 204. While not explicitly depicted in FIG. 2C, it is again assumed that all the communication depicted in group communication channel 202 of FIG. 2C is part of a single communication thread (or topic).

In step 210, user A 102a may post a message on group communication channel 202 that describes an issue. In step 212, automated service agent 114 may monitor group communication channel 202. In step 214, a triage operation similar to that described above in FIG. 2A may be performed by automated service agent 114. In the example of FIG. 2C, during the triage operation, automated service agent 114 is able to identify an issue from the messages posted in group communication channel 202, but automated service agent 114 is unable to determine a resolution to the issue on the spot. During the triage operation, automated service agent 114 additionally determines that user A 102a is the requestor of the issue. During the triage operation, automated service agent 114 additionally determines that use of private communication channel 204 would be helpful to resolve the issue.

At step 236, automated service agent 114 may post a message on group communication channel 202 that the issue has been assigned to an automated service agent. At step 232, automated service agent 114 may contact user A 102a via private communication channel 204 in order to attempt to resolve the issue. For instance, automated service agent 114 may send an SMS message to user A 102a (assuming that automated service agent 114 has the phone number of user A 102a readily available) or automated service agent 114 may send a DM to user A 102a (assuming that a user ID or login name of user A 102a is known to automated service agent 114). If not already apparent, there may be at least two ways in which automated service agent 114 can invite user A 102a to communicate with automated service agent 114 via private communication channel 204. In the embodiment of FIG. 2B (specifically step 228), an invitation to join private communication channel 204 may be sent to user A 102a via group communication channel 202. In the embodiment of FIG. 2C (specifically step 232), an invitation to join private communication channel 204 may be sent to user A 102a via private communication channel 204, this latter embodiment assuming that automated service agent 114 has the contact information of user A 102a readily available. In step 230, user A 102a may respond to the message of automated service agent 114 (step 230).

FIG. 2C illustrates that even before the communication between user A 102a and automated service agent 114 in private communication channel 204 has concluded, automated service agent 114 may post a status of the communication occurring in the private communication channel. Examples of messages that may be posted include a message that an approval request to a supervisor has been sent, a message that automated service agent 114 is actively working with user A 102a to resolve the issue, a message that communication between automated service agent 114 and user A has been idle for a time period, a message that user A 102a is in the process of providing additional information regarding the issue, etc.

At steps 240 and 242, user A 102a and automated service agent 114 continue their communication via private communication channel 204. Once the communication via the private communication channel has concluded (or temporarily ceased), automated service agent 114 may post, in group communication channel 202, information including at least one aspect of the communication with user A 102a that occurred in private communication channel 204. Such information could include a summary of the discussion between user A 102a and automated service agent 114, could include steps to place a purchase order, could include user A 102a rejecting the assistance of automated service agent 114, could include steps to request a software upgrade, could include the outcome of the attempt to resolve the issue (whether successful or not successful, etc.), etc.

FIG. 2D depicts time sequence diagram 200d of the communication that may occur via group communication channel 202 and private communication channel 204, and more specifically includes the collection of user information via private communication channel 204. While not explicitly depicted in FIG. 2D, it is again assumed that all the communication depicted in group communication channel 202 of FIG. 2D is part of a single communication thread (or topic).

In step 210, user A 102a may post a message on group communication channel 202 that describes an issue. In step 212, automated service agent 114 may monitor group communication channel 202. In step 214, a triage operation similar to that described above in FIG. 2B may be performed by automated service agent 114. Automated service agent 114 is able to identify an issue from the messages posted in group communication channel 202, but automated service agent 114 is unable to determine a resolution to the issue on the spot. During the triage operation, automated service agent 114 additionally determines that user A 102a is the requestor of the issue (e.g., based on the identity of the user who first describes the issue). During the triage operation, automated service agent 114 additionally determines that use of private communication channel 204 would be helpful to resolve the issue.

In step 228, automated service agent 114 may post a message on group communication channel 202 that invites user A 102a to communicate with automated service agent 114 via private communication channel 204. In the scenario of FIG. 2D, it is assumed that the user accepts the invitation from the automated service agent to join the private communication channel.

In step 244, automated service agent 114 requests information from user A 102a via private communication channel 204. The information requested is that needed to better understand the nature of the problem being experienced by the user and/or required to attempt a resolution thereof, and may include information such as the circumstances surrounding the events that led to the problem being experienced, actions by the user to self-remediate the problem (if any), diagnostic information that may be available from the user's computer system, and/or personal information of the user such as a login ID, a password, financial data (e.g., credit/debit card number, bank account number), personal information (e.g., date of birth, gender, address, social security number, etc.), etc. In step 246, user A 102a may provide the requested information to automated service agent 114 via private communication channel 204. While not discussed above, it is noted that such collection of information from user A 102a may similarly occur in one or more of steps 230 and 232 of FIG. 2B and one or more of steps 230, 232, 240 and 242 of FIG. 2C.

In the example of FIG. 2D, automated service agent 114 determines that it is best to let a human agent take over the servicing of the issue. Next, automated service agent 114 may contact human agent Y 104b via a private communication channel (not depicted in FIG. 2D), and communicate the collected user information to human agent Y 104b via the private communication channel. At step 248, automated service agent 114 may post a message on group communication channel 202 that notifies all users that human agent Y 104b will take over the servicing of the issue. At step 250, human agent Y 104b communicates with users via group communication channel 250 so as to attempt to service the issue.

In another embodiment (not depicted), it is possible that after determining that it is preferable to let a human agent take over the servicing of the issue, automated service agent 114 may post a message on group communication channel 202 asking for any available human agent that is monitoring group communication channel 202 to take over the servicing of the issue. Once a human agent responds (e.g., human agent X 104a), automated service agent 114 can communicate the collected user information to human agent X 104a via a private communication channel (not depicted), and human agent X 104a can take over the servicing of the issue.

FIG. 2E depicts time sequence diagram 200e of the communication between user A 102a and automated service agent 114 in group communication channel 202, communication between user A 102a and automated service agent 114 in private communication channel 204, and communication between human agent Y 104b and automated service agent 114 in private communication channel 206. While not explicitly depicted in FIG. 2E, it is again assumed that all the communication depicted in group communication channel 202 of FIG. 2E is part of a single communication thread (or topic).

In step 210, user A 102a may post a message on group communication channel 202 that describes an issue. In step 212, automated service agent 114 may monitor group communication channel 202. In step 214, a triage operation similar to that described above in FIG. 2C may be performed by automated service agent 114. Automated service agent 114 is able to identify an issue from the messages posted in group communication channel 202, but automated service agent 114 is unable to determine a resolution to the issue on the spot. During the triage operation, automated service agent 114 additionally determines that user A 102a is the requestor of the issue. During the triage operation, automated service agent 114 additionally determines that use of private communication channel 204 would be helpful to resolve the issue.

FIG. 2E depicts the use of one or more private communication channels (204, 206) in order to service the issue. Private communication channel 204 may be used by automated service agent 114 to communicate with user A 102a, and private communication channel 206 may be used by automated service agent 114 to communicate with human agent Y 104b. In the example of FIG. 2E, communication with user A 102a via private communication channel 204 is depicted prior to communication with human agent Y 104b via private communication channel 206, illustrating the scenario that information may be collected from user A 102a, and passed along to human agent Y 104b, which then either approves or denies a request from user A 102a. In another scenario (not depicted), it is possible for communication with human agent Y 104b via private communication channel 206 to precede communication with user A 102a via private communication channel 204, which might illustrate the scenario in which automated service agent 114 gathers information from human agent Y 104b, before passing along such information to user A 102a. In another scenario (not depicted), it is possible that communication with user A 102a via private communication channel 204 and communication with human agent Y 104b occur at the same time. In another scenario (not depicted), only communication with human agent Y 104b via private communication channel 206 may occur without communication with user A 102a via private communication channel 204. Once the communication via the private communication channels (204, 206) has concluded (or temporarily ceased), automated service agent 114 may post, in group communication channel 202, information including at least one aspect of the communication with user A 102a that occurred in private communication channel 204 and/or at least one aspect of the communication with human agent Y 104b that occurred in private communication channel 206.

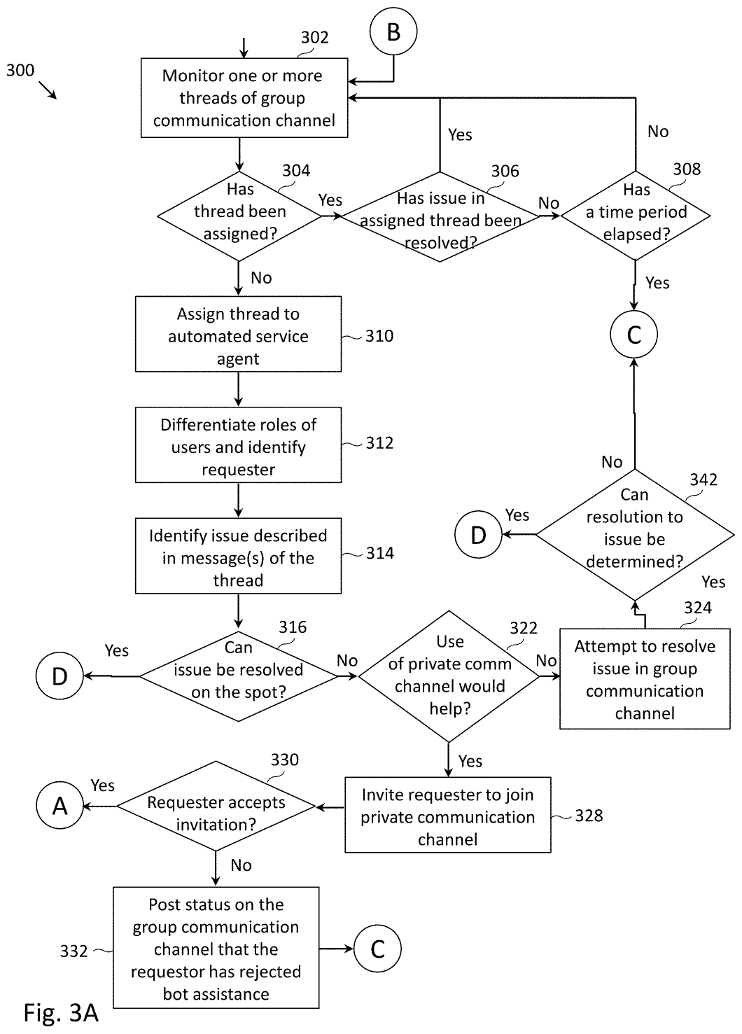

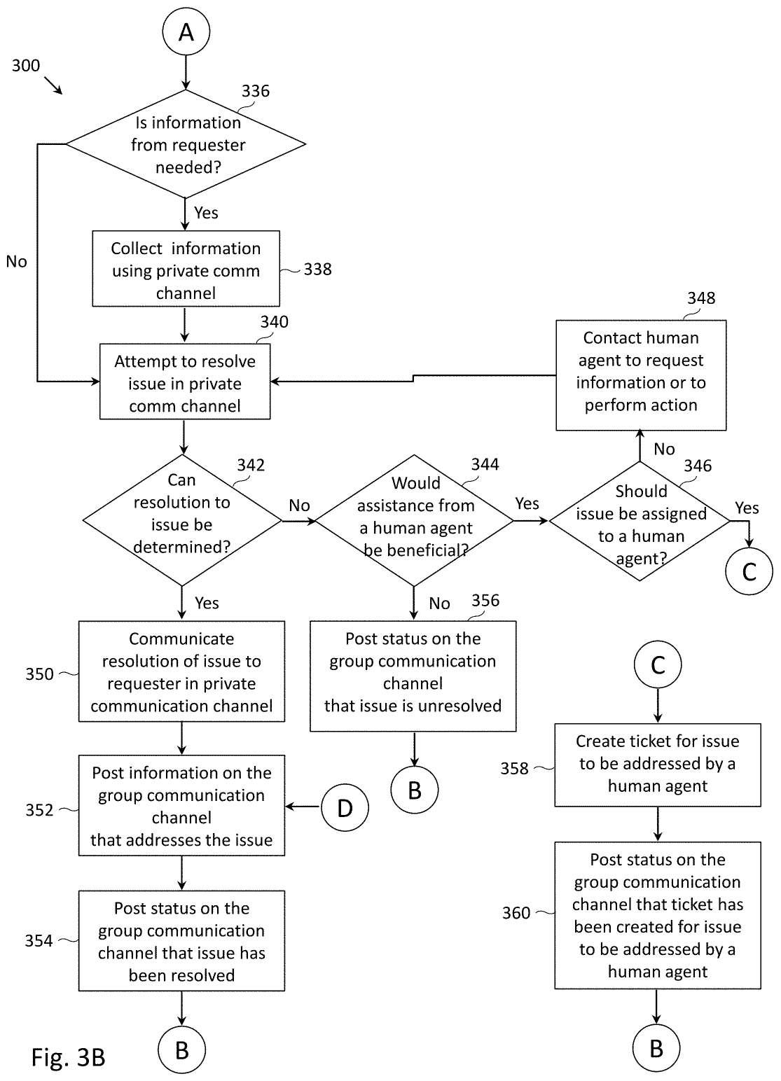

FIGS. 3A-3B depict a flow diagram of process 300 that may be performed by automated service agent 114 in order to service issues that are described in group communication channel 202. It is noted that flow diagram of FIGS. 3A-3B is meant to serve as an example of a process that may be performed by automated service agent 114, and that variations to such process are possible, including the insertion of additional steps, the removal of existing steps, the reordering of steps, etc.

At step 302, automated service agent 114 may monitor one or more communication threads of a group communication channel. The monitoring may include monitoring messages posted to the one or more communication threads of the group communication channel.

At step 304, automated service agent 114 may determine whether a communication thread had been assigned, either to an automated service agent or to a human agent. If so, automated service agent 114 may determine whether or not the issue identified in the assigned thread has been resolved. As will be described in FIG. 5A, one way for automated service agent 114 to make this determination is to check for the presence of a “check” emoji (or other graphical status indicator) being associated with the thread. If the “check” emoji is present, the issue has been resolved. Otherwise, the issue has not been resolved. If the issue has been resolved (Yes branch of step 306), the process may return to step 302. If the issue has not been resolved (No branch of step 306), automated service agent 114 may determine whether a time period has elapsed.

If a time period has not elapsed (No branch of step 308), this determination may indicate the issue that is currently being resolved by an agent, and to allow some additional time for the issue to be resolved. Accordingly, the action is essentially “do nothing”, and automated service agent 114 may return to step 302 and monitor one or more threads of group communication channel 202. If a time period has elapsed (Yes branch of step 308), this determination may indicate an issue that has been assigned to an agent, but that has not been successfully resolved by the agent after a period of time. Perhaps the agent has not even started looking into the issue, or the agent has started looking into the issue, but cannot find a satisfactory resolution to the issue. In response to such determination, automated service agent 114 may create a ticket for the issue to be addressed by a human (step 358) and post a status on group communication channel 202 that a ticket has been created for the issue to be addressed by a human (step 360). Following step 360, automated service agent 114 may return to previously described step 302 in which automated service agent 114 monitors one or more threads of a group communication channel.

Returning to step 304, if the thread has not been assigned (No branch of step 304), the thread may be assigned to automated service agent 114 (step 310). In step 312, automated service agent 114 may differentiate the roles of the users and identify one or more requesters. For example, any user that asks a question or states a problem may be identified as a requester. In another example, only the first user that asks a question may be identified as a requester. In another example, any users that provide instructions (e.g., “you should . . . ”) may be removed from consideration as a requester. For the sake of simplicity in the example of FIG. 3A, it is assumed that only one of the users is identified as the requester.

In step 314, automated service agent 114 may identify an issue described in one or more messages of the thread. The analysis of messages need not be limited to messages only from the requester, but an emphasis may be placed on messages from the requester, as those message may be more relevant in describing the issue of the requester. Identifying the issue from the one or more messages from the first user may utilize natural language processing (NLP). At step 316, automated service agent 114 may determine whether the issue can be resolved on the spot. In some instances, an issue may have been addressed in another thread, so automated service agent 114 can resolve the issue on the spot by repeating a previously provided resolution.

If the issue can be resolved on the spot (Yes branch of step 316), in step 352, automated service agent 114 may post information on the group communication channel (more specifically, post information in the communication thread assigned in step 310), such information providing a resolution to the issue described in the communication thread. At step 354, automated service agent 114 may post a status message on the group communication channel (more specifically, post a status message in the communication thread assigned in step 310) indicating that the issue has been resolved.

Returning to step 316, if the issue cannot be resolved on the spot (No branch of step 316), automated service agent 114 may determine whether use of a private communication channel with the requester would be beneficial. For instance, if private or sensitive information of the requester is needed to resolve the issue, automated service agent 114 may determine that use of a private communication channel with the requester would be beneficial.

If automated service agent 114 determines that use of a private communication channel would not be beneficial, automated service agent 114 may attempt to resolve in the issue in group communication channel 202 (step 324). If a resolution to the issue can be determined (Yes branch of step 342), automated service agent 114 may perform previously described steps 352 and 354. If a resolution to the issue cannot be determined (No branch of step 342), automated service agent 114 may perform previously described steps 358 and 360.

Returning to step 322, if automated service agent 114 determines that use of a private communication channel would be beneficial, automated service agent 114 may invite the requester to join a private communication channel (step 328) As previously mentioned, an invitation for a requester to join a private communication channel may include directions for a requester to click (or select) a link or for a requester to send an SMS message to a phone number.

If the requester does not accept the invitation to join the private communication channel (No branch of step 330), automated service agent 114 may post a status message on the group communication channel (more specifically, post information in the communication thread assigned in step 310) that the requester has rejected the assistance of automated service agent 114 (step 332), following by performing previously described steps 358 and 360. If the requester accepts the invitation to join the private communication channel (Yes branch of step 330), automated service agent 114 may determine in step 336 whether information (e.g., personal or sensitive information) from the requester is needed.

If information from the requester is needed (Yes branch of step 336), automated service agent 114 collects information from the requester in step 338 and attempts to resolve the issue in the private communication channel (step 340). If information from the requester is not needed (No branch of step 336), automated service agent 114 may proceed directly to step 340 and attempt to resolve the issue in the private communication channel. Attempting to resolve the issue in the private communication channel may include discussion between the requester and automated service agent 114 via the private communication channel. For example, automated service agent 114 can ask the requester whether certain measures have already been attempted.

At step 342, automated service agent 114 determines whether a resolution to the issue can be determined. If a resolution to the issue cannot be determined (No branch of step 342), automated service agent 114 may determine whether assistance from a human agent (e.g., system administrator, supervisor, colleague, etc.) would be beneficial. If assistance from a human agent would not be beneficial (No branch of step 344), automated service agent 114 may post a status message (step 356) on the group communication channel (more specifically, post information in the communication thread assigned in step 310) that the issue is unresolved, and return to previously described step 302. If assistance from a human agent would be beneficial (Yes branch of step 344), automated service agent 114 may determine whether the issue should be assigned to a human agent (i.e., whether the a human agent should take over). If the issue should be assigned to a human agent (Yes branch of step 346), automated service agent 114 may perform previously described steps 358 and 360. Otherwise, if the issue should not be assigned to a human agent (No branch of step 346), automated service agent 114 may contact a human agent to request information or to perform an action in step 348. For instance, automated service agent 114 may contact a person in the purchasing department to find out when a laptop will arrive. As another example, automated service agent 114 may contact a supervisor to authorize the purchase of a laptop. Following step 348, the process may resume from step 340.

Returning to step 342, if a resolution to the issue can be determined (Yes branch of step 350), automated service agent 114 may communicate (in step 350) the resolution of the issue to the requester in the private communication channel, followed by posting information (in step 352) that addresses the issue on the group communication channel (more specifically, post information in the communication thread assigned in step 310). In one embodiment, the information posted on the group communication channel (in step 352) may be identical to the information communicated in the private communication channel (in step 350). In another embodiment, the information posted on the group communication channel (in step 352) may be a shortened version of the information communicated in the private communication channel (in step 350), for example, omitting any personal or sensitive information of the requester. In another embodiment, the information posted on the group communication channel (in step 352) may be a summary of the information communicated in the private communication channel (in step 350). At step 354, automated service agent 114 may post a status message on the group communication channel (more specifically, post a status message in the communication thread assigned in step 310) indicating that the issue has been resolved, prior to returning to previously described step 302.

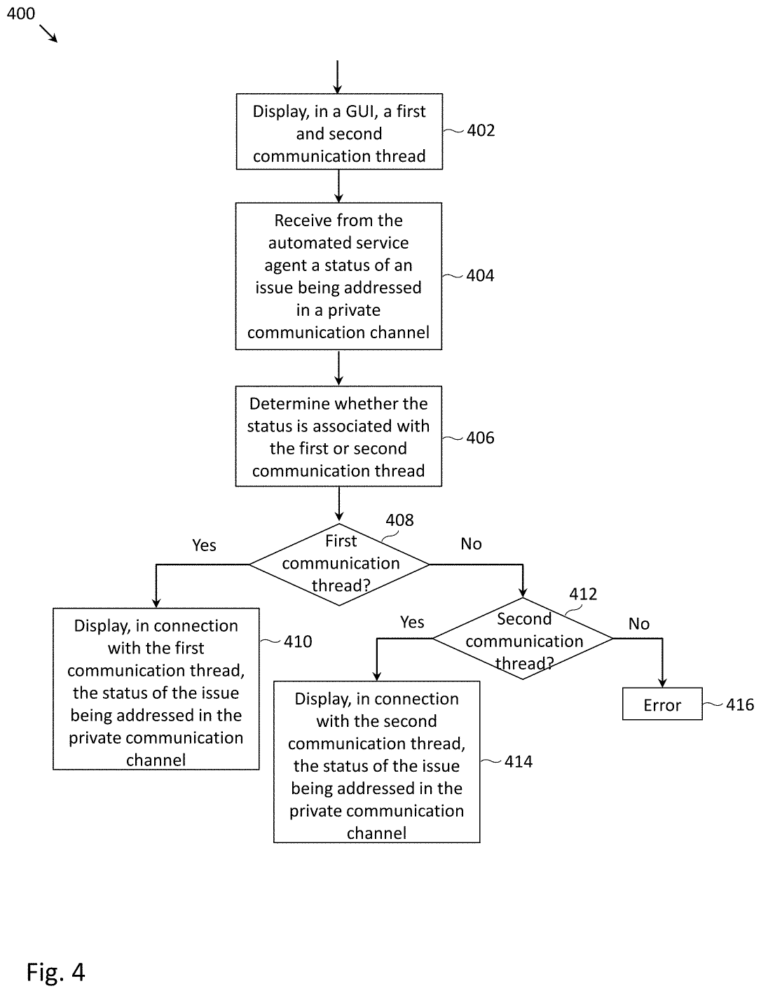

FIG. 4 depicts a flow diagram of process 400 that may be performed by group communication application 110. At step 402, group communication application 110 may cause a first and second communication thread to be displayed in a display of a client device (e.g., client device 106a). For example, group communication application 110 may cause first communication thread 502a and second communication thread 502b depicted in FIG. 5A to be displayed.

At step 404, group communication application 110 may receive, from automated service agent 114, a status of an issue being addressed in a private communication channel. In the example of FIG. 5A, the status may indicate that the issue associated with communication thread 502b has been resolved in private communication channel 204.

At step 406, group communication application 110 may determine whether the status is associated with the first or second communication thread. In the example of FIG. 5A, group communication application 110 may determine that the status is associated with second communication thread 502b. More specifically, each time the resolution of an issue is escalated from a communication thread of a group communication channel to a private communication channel, the private communication channel may be tagged with metadata that indicates the communication thread from which the issue was originally described. Such metadata may assist group communication application 110 with the determination of step 406.

In step 408, group communication application 110 may determine whether the status is associated with the first communication thread. If so (Yes branch of step 408), group communication application 110 may cause the status of the issue being addressed in the private communication channel to be displayed in connection with the first communication thread. If not (No branch of step 408), group communication application 110 may determine whether the status is associated with the second communication thread (step 412). If so (Yes branch of step 412), group communication application 110 may cause the status of the issue being addressed in the private communication channel to be displayed in connection with the second communication thread. If not (No branch of step 412), an error state (416) may be encountered in the scenario that there are only two communication threads, and the status is not associated with either of the communication threads. In the example of FIG. 5A, upon determining that the status of the issue being addressed in the private communication channel is associated with communication thread 502b, one can envision that a graphical status indicator (e.g., a “check” emoji) may be displayed in connection with communication thread 502b, indicating that the issue described in communication thread 502b has been resolved.

FIG. 5A depicts top level view 500 of multiple communication threads (502a, 502b, 502c) of a group communication channel. It should be apparent that the requester of communication threads 502a and 502b is a user named “Alice” and the requester of communication thread 502c is a user named “Bob”. For each of the communication threads (502a, 502b, 502c), a graphical representation of the requester may be displayed (which may include a picture of the requester, an emoji that represents the requester, etc.)

In top level view 500, each of the communication threads may display a brief synopsis of the issue being addressed in the respective communication threads. The brief synopsis could include a group of keywords, the initial message of the communication thread (which typically describes an issue), a summary of the issue, etc. In the example of FIG. 5A, the brief synopsis of communication thread 502a includes the initial message 504a (“Emails from my customer are going straight to the junk folder! Has this problem happened to anyone before?”); the brief synopsis of communication thread 502b includes the initial message 504b (“What's the guest wife?”); and the brief synopsis of communication thread 502c includes the initial message 504c (“Can I get <software X>”).

In top level view 500, each of the communication threads may also display one or more status indicators, specifically a graphical status indicator such as an emoji. In the example of FIG. 5A, communication thread 502a includes an “eyes” emoji 508a, indicating that the issue described in communication thread 502a has been assigned (either to a human agent or an automated service agent). The “1” next to the eyes emoji 508a specifically indicates that the issue has been assigned to one agent. In the example of FIG. 5A, communication thread 502a also includes a “checkmark” emoji 508b, indicating that the issue described in communication thread 502a has been successfully resolved. The “1” next to the “checkmark” emoji 508b indicates that the issue described in communication thread 502a has been successfully resolved one time. It is noted that an issue could be successfully resolve multiple times. For instance, a human agent and an automated service agent could each resolve an issue, and result in the number “2” being displayed next to a checkmark emoji. As another example, if multiple solutions are posted to address a single issue, a number greater than “1” could again be associated with the checkmark emoji.

In the example of FIG. 5A, communication threads 502b and 502c also include “eyes” emojis 508c and 508d, respectively, indicating that the issues described in communication threads 502b and 502c have been assigned (either to a human agent or an automated service agent). The “2” next to the “eyes” emojis 508c and 508d, indicates that the issues have each been assigned to two agents. The lack of any checkmark emojis for communication threads 502b and 502c indicates that the issues described in these communication threads have not yet been resolved.

The display of graphical status indicators in the top level view is useful as it allows an agent (whether a human agent or automated service agent) or users in general to quickly determine whether a communication thread has been assigned, whether the issue described in a communication thread has been resolved, etc. In the case that an issue has been assigned, but has not been resolved for a long period of time (e.g., 1 day), an agent (whether a human agent or automated service agent) may more closely examine the associated thread to see if additional assistance is needed to help resolve the issue.

In the top level view, a user interface element (506a, 506b, 506c) may also be displayed with each of the communication threads (502a, 502b, 502c), and clicking on (or more generally, performing a selection action on) such user interface element may cause a bottom level view of the communication thread to be displayed. In the example of FIG. 5A, selection of user interface element 506a causes the top level view of communication thread 502a to be transformed into the bottom level view of communication thread 502a displayed in FIG. 5B.

The bottom level view of communication thread 502a includes messages from Alice, a user named “Kat”, a user named “George” and an automated service agent named “Bot”. It should be apparent that Alice, Kat and George are all users of a group communication channel, and that Bot is able to monitor the messages of the group communication channel. In the bottom level view, message 504a from Alice is displayed (“Emails from my customer are going straight to the junk folder! Has this problem happened to anyone before?”). In real time (e.g., almost instantaneously), automated service agent 114 (or “Bot”) is able to identify an issue from message 504a of Alice (e.g., emails from trusted sender are being received in the junk folder). Automated service agent 114 is also able to recognize that Alice is the requester of the issue based on the issue being described in Alice's message. Automated service agent 114 posts message 522a inviting Alice to join a private communication channel (“Alice, I think I can help you. Can you join me in a DM by clicking this link? xyz.privatechat/123 I will need your email login credentials to check on your email settings”). Automated service agent 114 may also trigger the display of the “eyes” emoji 508a, indicating that the thread has been assigned (in this case, assigned to the automated service agent). In the present example, message 522a from automated service agent 114 is followed by message 522b from Kat (“Nope! Sorry . . . ”). Message 522b from Kat is followed by message 522c from George (“Yes it's such an annoying problem, but I've not been able to find a solution”). Next, automated service agent 114 posts message 522d regarding the status of handling the issue in the private communication channel (“ . . . working with Alice in a private chat to fix the email issue”). Finally, automated service agent 114 posts message 522e, indicating that the issue has been resolved (“Email problem has been resolved!”) and how the issue was resolved (“I helped Alice input her customer's email address into a Senders Whitelist. FYI—you can find this whitelist under the settings tab.”). Automated service agent 114 also triggers the display of the “checkmark” emoji 508b, indicating that the issue has been resolved.

FIG. 6 depicts an example of communication 600 between Alice and the automated service agent that takes place via a private communication channel, that occurs after Alice selects link 524 in message 522a. Such communication may be displayed in a fashion that it is clear such communication is not part of the communication of the group communication channel. For instance, communication 520 may be displayed in the main panel of a window, and communication 600 may be displayed in a sidebar of the window. As another example, communication 520 may be displayed in one window and communication 600 may be displayed in another window. As another example, communication 520 may be displayed by one software application (e.g., Slack), while communication 600 may be displayed by another software application (e.g., Lync). As another example, communication 520 may be display by client device 106a, while communication 600 may be displayed by client device 106b.

In the example of FIG. 6, automated service agent 114 collects private information from Alice, by sending message 602a (“Hey Alice! Would you mind sending me your email login?”). In response, Alice provides her email login in message 602b (“awzheart”). Automated service agent 114 collects additional private information from Alice by sending message 602c (“Thanks! How about your email password?”). In response Alice provides her email password in message 602d (“x123\hat{ }xy”). Next, automated service agent 114 notifies Alice that the automated service agent will attempt to resolve the issue by sending message 602e (“Perfect! I'll do a little research on your email settings”). Next, automated service agent 114 notifies Alice of one possible cause of the issue, by sending message 602f (“I see that your Senders Whitelist is empty”).

It is noted that at this time (i.e., at 1:30 PM), automated service agent 114 also posts status update 522d on the group communication channel (referring back to FIG. 5B), which further illustrates step 238 of FIG. 2C. Next, automated service agent 114 takes measures to attempt to resolve the issue, and send message 602g to Alice (“What's your customer's email address? I can help you input that into the Senders Whitelist”). Alice then responds to the request of the automated service agent, by sending message 602h (“<name>at<domain>dot<com>”). Next, automated service agent 114 communicates to Alice that the issue has been resolved and how the issue was resolved, by sending message 602i (“Got it! Senders Whitelist has been populated with <name>at<domain>dot<com>Your email problem should be solved. If you still encounter this problem, let me know”). Next, Alice concludes communication 600 in the private communication channel with a message 602j of appreciation (“Thanks!”).

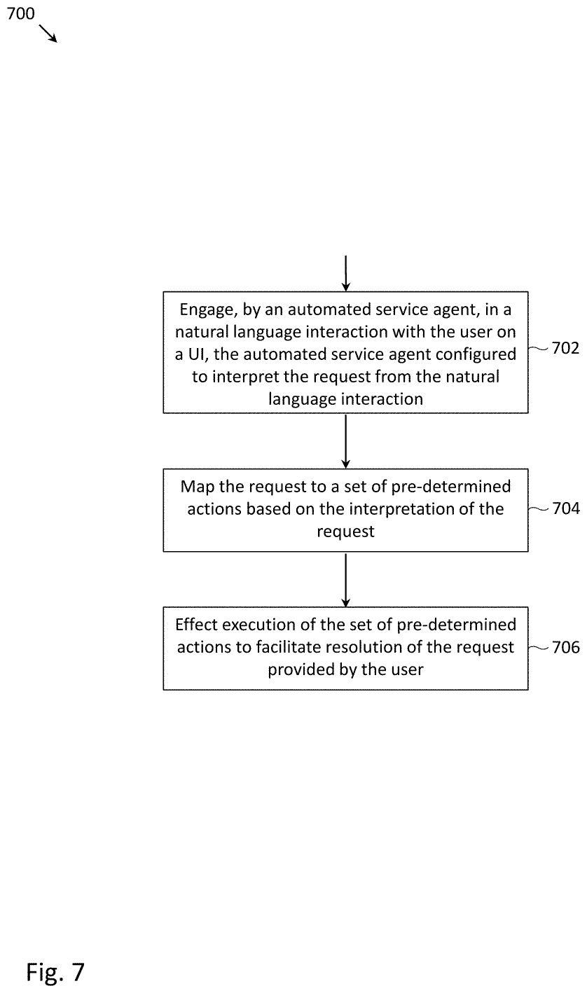

FIGS. 7-9 describe additional functionality of automated service agent 114. FIG. 7 depicts a flow diagram of process 700 for facilitating task automation. At step 702, automated service agent 114 may engage in a natural language interaction with the user on a user interface (UI). Automated service agent 114 may be configured to interpret the request from the natural language interaction.

At step 704, the user request may be mapped to a set of pre-determined actions based on the interpretation of the request. The interpretation of the user request and the mapping of the request to the set of pre-determined actions may be performed based on learning from responses provided to the user requests, their outcomes, past tickets, frequently asked questions by users, and the like. Automated service agent 114 may be configured to leverage such machine learning (ML) capabilities and use natural language processing (NLP) to engage in interactions with the users. Furthermore, automated service agent 114 may also be caused to leverage unstructured or “private” data—from external knowledge databases (such as Wikipedia for instance), online question-answer forums, run books and past chat transcripts to achieve accurate interpretation of user requests.

At step 706, execution of the set of pre-determined actions is effected to facilitate resolution of the request provided by the user. In some embodiments, automated service agent 114 may be configured to connect with one or more applications to effect automatic execution of the set of pre-determined actions. In an illustrative example, automated service agent 114 may be configured to connect to the servers hosting relevant service applications such as Google Groups™, Microsoft AD™, Okta™, among others to perform various actions. In some cases, this may involve making specific API calls (REST or Soap), and in other instances it may involve making modifications to a database. In an embodiment, an entry corresponding to each executed action may be logged for meeting at least one of compliance and audit requirements. In at least one example embodiment, the entries may be logged in the form of tickets. Further information regarding process 700 may be found in application Ser. No. 15/466,791 (filed on 22 Mar. 2017), which is incorporated herein by reference in its entirety.

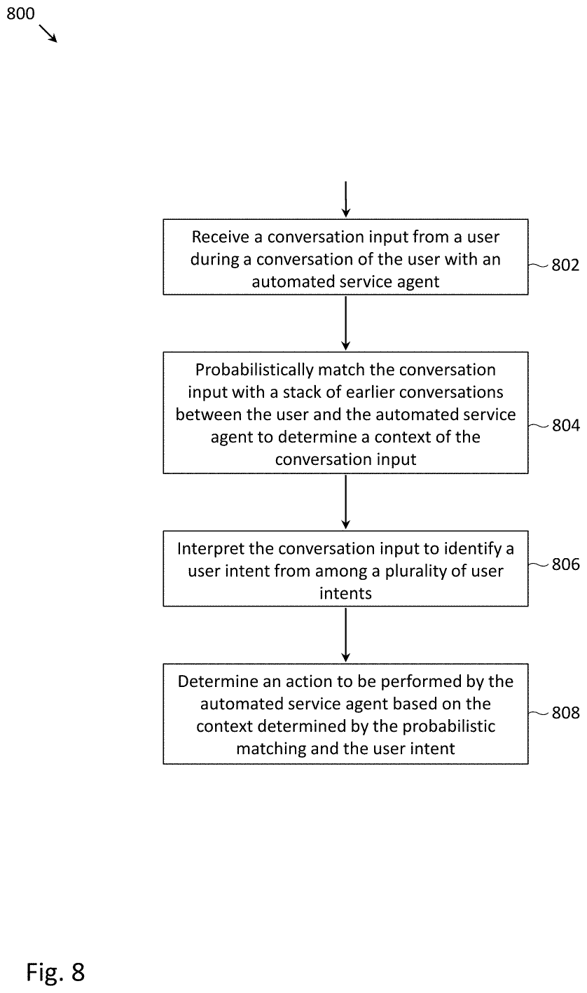

FIG. 8 depicts a flow diagram of process 800 for facilitating an automated communication between a user and an automated service agent. The operations of process 800 may be performed by automated service agent 114. At step 802, automated service agent 114 may receive a conversation input from a user during a conversation with the user. At step 804, automated service agent 114 may probabilistically match the conversation input with a stack of earlier conversations between the user (or other users) and automated service agent 114 to determine a context of the conversation input. The context may be determined from one or more contexts associated with the stack of earlier conversations. Automated service agent 114 may look up the stack of earlier conversations to determine if an input relates to a new context or an ongoing context associated with the stack of earlier conversations. If the input received from the user matches at least one context associated with the stack of earlier conversations, automated service agent 114 may determine that an input relates to the ongoing context. Automated service agent 114 further may determine that an input relates to a new context if the input received from the user does not match or cannot be mapped to a context associated with the stack of earlier conversations.

At step 806, the conversation input may be interpreted to identify a user intent from among a plurality of user intents. A natural language processor may parse the input messages and an intent model may interpret the user intent from the parsed data, wherein the identified user intent is one of a plurality of stored user intents. The intent model may further store the input messages and the parsed data (data strings) corresponding to the input messages in a table. At step 808, automated service agent 114 may determine an action to perform based on the context determined by the probabilistic matching and the user intent. The action may include a resolution to an issue. Further information regarding process 800 may be found in application Ser. No. 15/688,190 (filed on 28 Aug. 2017), which is incorporated herein by reference in its entirety.

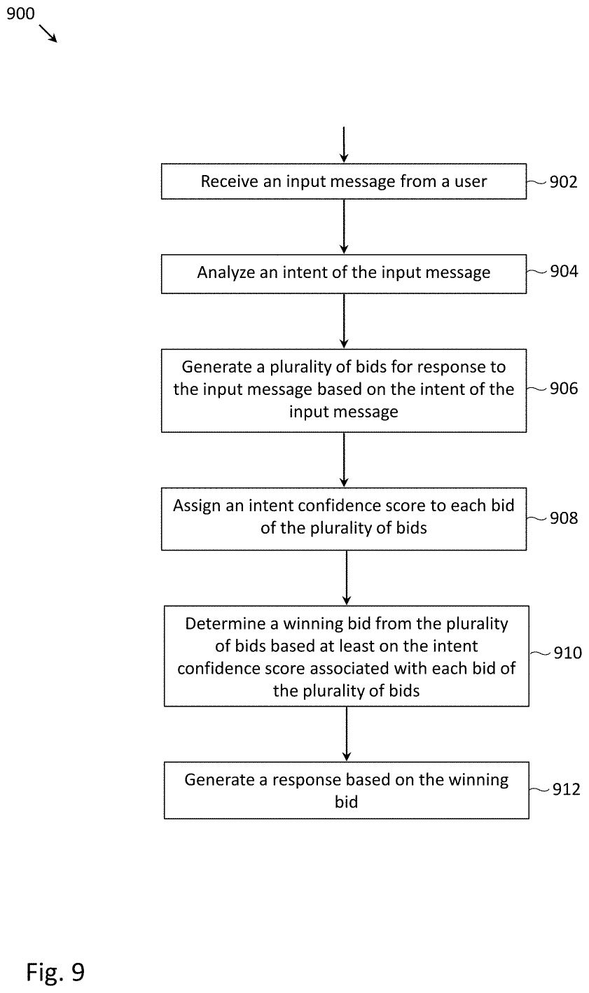

FIG. 9 depicts a flow diagram of process 900 for facilitating an automated communication between a user and an automated service agent. The process 900 depicted in the flow diagram may be executed by, for example, automated service agent 114. At step 902, automated service agent 114 may receive an input message from a user. The input message may be one of a voice message, a text message or an audio-video message, and may be in a question format. The input message may have at least one intent of the user related to a user request. For instance, the input message may be a user request to obtain access to “software A”.

At step 904, automated service agent 114 may analyze an intent of the input message. At step 906, bidding modules of automated service agent 114 may generate a plurality of bids (e.g., B1, B2, B3) for response to the input message based on the intent of the input message. Each of the bidding modules may be able to serve the user request present in the input message, and may be willing to participate in serving the user request. At step 908, automated service agent 114 may assign an intent confidence score to each bid of the plurality of bids. For instance, the intent confidence scores such as S1, S2, and S3 may be assigned to the bids B1, B2 and B3, respectively. In an example embodiment, each of the bidding modules may provide corresponding intent confidence score.

At step 910, automated service agent 114 may determine a winning bid from the plurality of bids based at least on the intent confidence score associated with each bid from the plurality of bids. For instance, automated service agent 114 may consider the intent confidence scores S1, S2 and S3 for the bids B1, B2 and B2 to determine the winning bid. As an example, the bid B1 may be determined as the winning bid. At step 912, automated service agent 114 may generate a response (which may be a resolution to an issue) based on the winning bid. Further information regarding process 900 may be found in application Ser. No. 16/166,179 (filed on 22 Oct. 2018), which is incorporated herein by reference in its entirety.

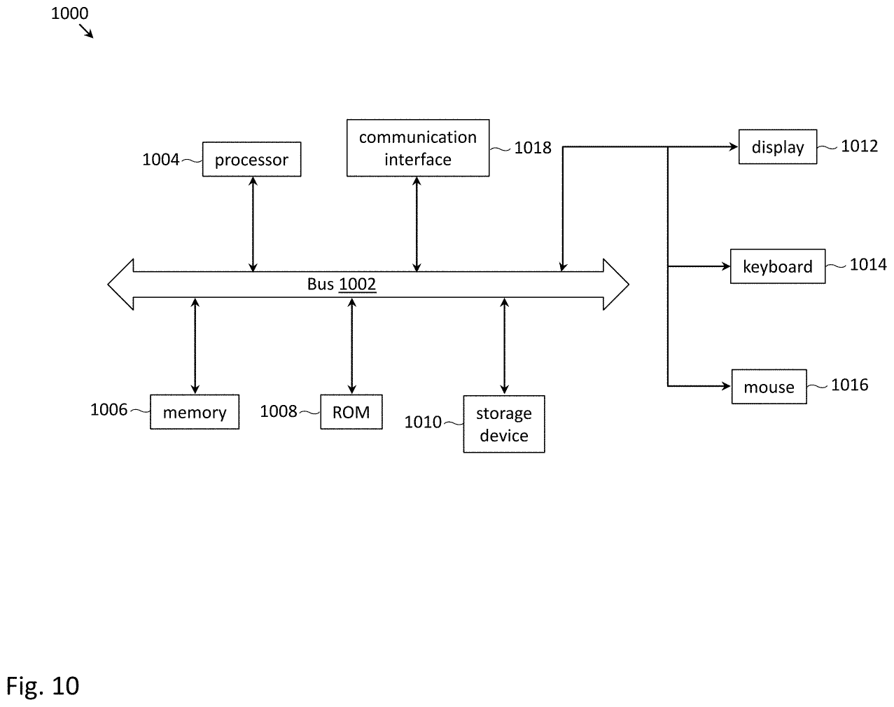

As is apparent from the foregoing discussion, aspects of the present invention involve the use of various computer systems and computer readable storage media having computer-readable instructions stored thereon. FIG. 10 provides an example of a system 1000 that may be representative of any of the computing systems (e.g., client devices 106a, . . . , 106f, servers 112, 116, 120) discussed herein. Examples of system 1000 may include a smartphone, a desktop, a laptop, a mainframe computer, an embedded system, etc. Note, not all of the various computer systems have all of the features of system 1000. For example, certain ones of the computer systems discussed above may not include a display inasmuch as the display function may be provided by a client computer communicatively coupled to the computer system or a display function may be unnecessary. Such details are not critical to the present invention.

System 1000 includes a bus 1002 or other communication mechanism for communicating information, and a processor 1004 coupled with the bus 1002 for processing information. Computer system 1000 also includes a main memory 1006, such as a random access memory (RAM) or other dynamic storage device, coupled to the bus 1002 for storing information and instructions to be executed by processor 1004. Main memory 1006 also may be used for storing temporary variables or other intermediate information during execution of instructions to be executed by processor 1004. Computer system 1000 further includes a read only memory (ROM) 1008 or other static storage device coupled to the bus 1002 for storing static information and instructions for the processor 1004. A storage device 1010, for example a hard disk, flash memory-based storage medium, or other storage medium from which processor 1004 can read, is provided and coupled to the bus 1002 for storing information and instructions (e.g., operating systems, applications programs and the like).

Computer system 1000 may be coupled via the bus 1002 to a display 1012, such as a flat panel display, for displaying information to a computer user. An input device 1014, such as a keyboard including alphanumeric and other keys, may be coupled to the bus 1002 for communicating information and command selections to the processor 1004. Another type of user input device is cursor control device 1016, such as a mouse, a trackpad, or similar input device for communicating direction information and command selections to processor 1004 and for controlling cursor movement on the display 1012. Other user interface devices, such as microphones, speakers, etc. are not shown in detail but may be involved with the receipt of user input and/or presentation of output.

The processes referred to herein may be implemented by processor 1004 executing appropriate sequences of computer-readable instructions contained in main memory 1006. Such instructions may be read into main memory 1006 from another computer-readable medium, such as storage device 1010, and execution of the sequences of instructions contained in the main memory 1006 causes the processor 1004 to perform the associated actions. In alternative embodiments, hard-wired circuitry or firmware-controlled processing units may be used in place of or in combination with processor 1004 and its associated computer software instructions to implement the invention. The computer-readable instructions may be rendered in any computer language.

In general, all of the above process descriptions are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying”, “receiving”, “transmitting” or the like, refer to the action and processes of an appropriately programmed computer system, such as computer system 1000 or similar electronic computing device, that manipulates and transforms data represented as physical (electronic) quantities within its registers and memories into other data similarly represented as physical quantities within its memories or registers or other such information storage, transmission or display devices.

Computer system 1000 also includes a communication interface 1018 coupled to the bus 1002. Communication interface 1018 may provide a two-way data communication channel with a computer network, which provides connectivity to and among the various computer systems discussed above. For example, communication interface 1018 may be a local area network (LAN) card to provide a data communication connection to a compatible LAN, which itself is communicatively coupled to the Internet through one or more Internet service provider networks. The precise details of such communication paths are not critical to the present invention. What is important is that computer system 1000 can send and receive messages and data through the communication interface 1018 and in that way communicate with hosts accessible via the Internet. It is noted that the components of system 1000 may be located in a single device or located in a plurality of physically and/or geographically distributed devices.

Thus, an automated service agent for servicing issues described in a group communication channel has been described. It is to be understood that the above-description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

1. A method, comprising:
monitoring, by an automated service agent, messages communicated via a first communication thread of a group communication channel, wherein information communicated via the group communication channel is accessible to a group of users and the automated service agent, and wherein the group of users includes a first user;
identifying, by the automated service agent, an issue from at least one message, from the first user, that is present in the first communication thread of the group communication channel, wherein the issue has not already been assigned, and wherein identifying the issue from the at least one message from the first user utilizes natural language processing;
in response to determining that the issue is better addressed using a first private communication channel with the first user rather than using the group communication channel, posting, by the automated service agent, a message on the first communication thread that invites the first user to communicate with the automated service agent on the first private communication channel;
communicating, by the automated service agent, with the first user on the first private communication channel so as to attempt to resolve the issue, wherein communication via the first private communication channel is restricted to only the automated service agent and the first user from the group of users;
determining, by the automated service agent, a status of the issue being addressed in the first private communication channel;
posting, by the automated service agent, the status of the issue being addressed in the first private communication channel on the first communication thread of the group communication channel; and
posting, by the automated service agent, information that addresses the issue on the first communication thread of the group communication channel.

2. The method of claim 1, wherein the group communication channel includes the first communication thread and a second communication thread, and wherein the automated service agent monitors messages communicated via the first and second communication threads.

3. The method of claim 1, further comprising prior to communicating with the first user on the first private communication channel, posting, by the automated service agent, a message on the first communication thread that invites the first user to communicate with the automated service agent on the first private communication channel.

4. The method of claim 1, wherein communicating, by the automated service agent, with the first user on the first private communication channel comprises transmitting a message to the first user on the first private communicate channel, the message inviting the first user to communicate with the automated service agent via the first private communication channel.

5. The method of claim 1, wherein the issue includes an identification of a problem, and wherein the information that addresses the issue advances the issue towards a solution.

6. The method of claim 1, wherein the issue includes a request for assistance, and wherein the information that addresses the issue provides assistance to the request.

7. The method of claim 1, further comprising subsequent to identifying the issue from the at least one message from the first user, communicating, by the automated service agent, with a human agent on a second private communication channel so as to attempt to resolve the issue, wherein communication via the second private communication channel is restricted to only the automated service agent and the human agent.

8. The method of claim 7, further comprising subsequent to identifying the issue from the at least one message from the first user, and prior to communicating with the human agent on the second private communication channel, collecting information, by the automated service agent, regarding the first user via the first private communication channel, and transmitting the collected information regarding the first user to the human agent via the second private communication channel.

9. The method of claim 7, wherein the human agent is a system administrator, a supervisor of the first user or a colleague of the first user.

10. The method of claim 1, wherein the status of the issue being addressed in the first private communication channel indicates that one or more of the issue has been assigned to the automated service agent, the issue has been assigned to a human agent, a purchase order has been placed to resolve the issue, the first user has rejected assistance from the automated service agent, an approval request in association with the issue has been sent to the human agent, the automated service agent is actively working with the first user to resolve the issue, communication between the automated service agent and the first user has been idle for a time period, or the first user is providing additional information regarding the issue to the automated service agent.

11. The method of claim 1, further comprising subsequent to identifying the issue from the at least one message from the first user, collecting information, by the automated service agent, regarding the first user via the first private communication channel, and posting, by the automated service agent, a request on the group communication channel, the request requesting a human agent to contact the automated service agent to resolve the issue.

12. The method of claim 1, further comprising communicating, by the automated service agent and on the first private communication channel, information to the first user that addresses the issue.

13. The method of claim 12, wherein the information posted on the first communication thread of the group communication channel that addresses the issue is a shortened version of the information communicated on the first private communication channel to the first user.

14. The method of claim 1, wherein the issue is determined to be better addressed using the first private communication channel rather than using the group communication channel if resolution of the issue requires private information of the first user.

15. The method of claim 1, wherein the status of the issue that is posted on the first communication thread includes a graphical status indicator.

16. The method of claim 1, wherein the information that is posted on the first communication thread of the group communication channel and that addresses the issue is based on information previously posted on a second communication thread of the group communication channel.

17. The method of claim 1, wherein in order for the automated service agent to determine the information that addresses the issue, the automated service agent is trained with one or more of publicly available data, and private enterprise domain data.

18. The method of claim 1, further comprising, in response to the automated service agent detecting that a second communication thread has not been resolved within a certain time period after a commencement of the second communication thread, contacting, by the automated service agent, a human agent to address the unresolved second communication thread or filing a ticket to allow tracking of the unresolved second communication thread.

19. The method of claim 1, further comprising, in response to the automated service agent detecting one or more trending issues in the group communication channel, sending, by the automated service agent, an announcement to the group communication channel, wherein the announcement contains information regarding the one or more trending issues.

20. The method of claim 1, further comprising in response to the automated service agent detecting one or more trending issues or trouble shooting patterns in the group communication channel, communicating, by the automated service agent, with a human agent on a second private communication channel so as to inform the human agent of the one or more trending issues or trouble shooting patterns, wherein communication via the second private communication channel is restricted to only the automated service agent and the human agent.

21. The method of claim 1, further comprising in response to the automated service agent detecting an ongoing outage, sending, by the automated service agent, an announcement to the group communication channel, wherein the announcement contains information regarding a status of the ongoing outage.

22. A method, comprising:
displaying a first and second communication thread from the group communication channel in a graphical user interface (GUI), wherein information communicated via the group communication channel is accessible to a group of users and an automated service agent, and wherein the group of users includes a first user;
receiving, from the automated service agent, a status of an issue being addressed in a private communication channel, wherein communication via the private communication channel is restricted to only the automated service agent and the first user from the group of users;
determining whether the issue is associated with the first or second communication thread based on metadata tagged with the private communication channel, the metadata indicating a communication thread from which the issue was originally described; and
in response to determining that the issue is associated with the first communication thread, displaying, in the GUI and in connection with the first communication thread, the status of the issue being addressed in the private communication channel.

23. The method of claim 22, wherein the first communication thread is displayed in a top level view that contains a selectable region that, upon selected, causes the top level view to be transformed into a bottom level view that displays additional information regarding the first communication thread.

24. The method of claim 22, wherein the status of the issue indicates that one or more of the issue has been assigned to a human agent, a purchase order has been placed to resolve the issue, the first user has rejected assistance from the automated service agent, an approval request has been sent to the human agent in association with the issue, or the issue has been resolved.

25. The method of claim 22, wherein the status of the issue displayed in the first communication thread of the top level view of the group communication channel includes a graphical status indicator.

26. The method of claim 22, wherein the first communication thread and the second communication thread are displayed in a top level view, and wherein the top level view includes a synopsis of the issue associated with the first communication thread and a synopsis of an issue associated with the second communication thread.

27. The method of claim 22, wherein the issue includes one or more of an identification of a problem or a request for assistance.
